(19) United States
(12) Patent Application Publication
(10) Pub. No.: US 2004/0261930 A1
(43) Pub. Date: Dec. 30, 2004

(54) Method of bonding substrates and apparatus for bonding substrates

(75) Inventor: Shinichi Ogimoto, Yokohama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shibaura Mechatronics Corporation, Yokohama-shi (JP)

(21) Appl. No.: 10/786,402

(22) Filed: Feb. 25, 2004

(30) Foreign Application Priority Data
Mar. 4, 2003 (JP) 2003-057295
Mar. 19, 2003 (JP) 2003-075785

(51) Int. Cl. B32B 31/00

(52) U.S. Cl. 156/64; 156/350

(57) ABSTRACT

There is disclosed a method comprising bonding two substrates to each other by a sealing agent, obtaining a positional shift amount between the bonded two substrates, and moving at least one of the two substrates by a correction movement amount obtained by multiplying the positional shift amount by a correction coefficient larger than 1 to correct the positional shift amount between these two substrates.

### CROSS-REFERENCE TO RELATED APPLICATIONS

This application is based upon and claims the benefit of priority from the prior Japanese Patent Applications No. 2003-57295, filed Mar. 4, 2003; and No. 2003-75785, filed Mar. 19, 2003, the entire contents of which are incorporated herein by reference.

### BACKGROUND OF THE INVENTION

1. Field of the Invention

The present invention relates to a method of bonding substrates and a bonding apparatus in which two substrates are bonded to each other as in a liquid crystal display panel.

2. Description of the Related Art

As well known, during manufacturing of a liquid crystal display panel, two transparent substrates are bonded to each other via a sealing agent, and a liquid crystal, which is a liquid material, is disposed between these substrates to assemble the substrates.

Two substrates have heretofore been assembled by a step of coating one substrate with a sealing agent formed of a viscous/elastic material in a rectangular frame shape, a step of dropping a predetermined amount of liquid crystal on one or the other substrate, and a step of bonding two substrates to each other by the sealing agent under a reduced pressure atmosphere.

A spacer is disposed in an interval in order to secure an interval of the order of μm between two bonded substrates. As the spacer, a ball spacer for spraying a spherical resin whose particle diameter is several μm onto the inner surface (bonded surface) of one substrate, a photo spacer in which protrusions each having a height of several μm are disposed on the inner surface of one substrate, and the like are known.

To bond two substrates to each other, first, two substrates are disposed apart from each other at a predetermined interval, an image is picked up, and these substrates are roughly positioned based on an image pickup result. Subsequently, two substrates are bonded to each other by the sealing agent, the images of two substrates are further picked up in this state, and one substrate is moved in a predetermined direction by a predetermined amount based on the image pickup result. Accordingly, two substrates are precisely positioned. The movement amount of the substrate in this case is set to be equal to a shift amount obtained from the image pickup result.

When two bonded substrates are precisely positioned, and when one substrate is moved, the spacer is interlocked with the movement of the substrate. When the spacer is the ball spacer, the spacer rolls by the movement of the substrate, and a frictional resistance exerted between the substrates is comparatively small. However, when the spacer is the photo spacer, the spacer slide-contacts the substrate in a surface contact state, the frictional resistance increases.

When the frictional resistance between the substrates is large, and when the substrate on the moving side is moved by a predetermined amount, the frictional resistance exerted on the moved substrate is sometimes larger than a holding force with which the substrate has been held. In this case, even when holding means of the substrate is moved by a movement amount equal to a shift amount based on the image pickup result, an actual movement amount of the substrate is smaller than a shift amount, and therefore two substrates cannot be positioned with high precision.

Therefore, the above-described positioning operation has to be performed many times in order to precisely position two substrates in an allowable precision, and therefore a drop in productivity is sometimes caused.

Additionally, in a case where the positional shift amount of two substrates based on the image pickup result is small, even when the substrate is moved in accordance with the small positional shift amount, in actuality the substrate does not move in a direction for correcting the shift, due to frictional resistance in some cases. In this case, it is difficult to position the substrates precisely.

An object of the present invention is to provide a method of bonding substrates and a bonding apparatus in which two bonded substrates can be quickly and precisely positioned.

### BRIEF SUMMARY OF THE INVENTION

According to the present invention, there is provided a method of bonding substrates, comprising:

bringing two substrates into contact with each other via a sealing agent or a liquid substance;

obtaining a positional shift amount between two substrates brought into contact; and

moving at least one of the two substrates by a correction movement amount obtained by multiplying the positional shift amount by a correction coefficient which is larger than 1 to correct a positional shift between the two substrates.

According to the present invention, one substrate is moved by the correction movement amount which is larger than a shift amount from the other substrate. Accordingly, even when either substrate shifts/moves due to frictional resistance with the other substrate, positioning can be quickly and securely performed compensating for the shift amount.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory view showing a schematic constitution of an apparatus for assembling a liquid crystal display panel according to one embodiment of the present invention;

FIG. 2 is a sectional view of a bonding apparatus for bonding two substrates to each other;

FIG. 3 is a block diameter of a control system;

FIG. 4 is a flowchart showing manufacturing steps when bonding two substrates to each other;

FIG. 5 is a flowchart showing steps subsequent to those of FIG. 4;

FIG. 6 is an enlarged sectional view showing a part of the liquid crystal display panel in which a photo spacer is disposed;

FIG. 7 is a main part front view showing the apparatus for bonding the substrates according to a second embodiment of the present invention;

FIG. 8 is an enlarged perspective view of an elastic member of the apparatus shown in FIG. 7;

FIG. 9 is a plan view at a time when the elastic member shown in FIG. 8 is cut in an arrow direction from a IX-IX line;

FIG. 10 is a main part enlarged front view of the second embodiment shown in FIG. 7;

FIG. 11 is a main part enlarged front view showing a state in which the substrates are positioned from a state shown in FIG. 10;

FIG. 12 is a main part enlarged front view showing a state in which the substrate has pressed an adhesive from a state shown in FIG. 11;

FIG. 13 is a main part enlarged front view showing a state in which a deformation amount of the elastic member shown in FIG. 12 is set to zero;

FIG. 14 is a flowchart showing a method of bonding the substrates in the second embodiment shown in FIG. 7;

FIG. 15 is a flowchart showing the method of bonding the substrates in a third embodiment according to the present invention; and

FIG. 16 is a flowchart showing the method of bonding the substrates in a fourth embodiment according to the present invention.

### DETAILED DESCRIPTION OF THE INVENTION

Embodiments of the present invention will be described hereinafter with reference to the drawings.

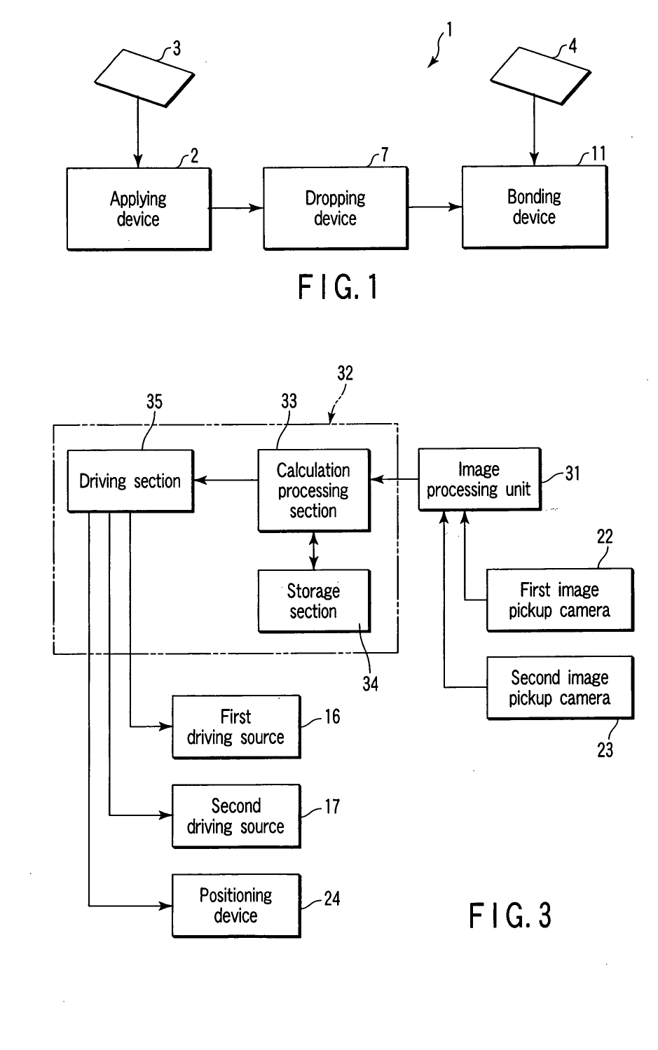

FIGS. 1 to 6 show a first embodiment of the present invention, and FIG. 1 is an explanatory view showing a schematic constitution of an assembling apparatus 1 for a liquid crystal display panel. The assembling apparatus 1 includes a applying device 2 of a sealing agent. A first substrate 3 which is one of first and second substrates 3, 4 constituting a liquid crystal display panel P shown in FIG. 6 is supplied to the applying device 2.

The applying device 2 includes a table on which the first substrate 3 is supplied/laid and a applying nozzle disposed above the table (both are not shown). When this applying nozzle is relatively driven in X, Y and Z directions with respect to the first substrate 3, the inner surface of the first substrate 3 is applied with a sealing agent 5 formed of a viscous/elastic material (shown in FIG. 6) in a rectangular frame shape.

The first substrate 3 applied with the sealing agent 5 is supplied to a dropping device 7. The dropping device 7 includes a table on which the first substrate 3 is laid and a dropping nozzle disposed above the table (both are not shown), and this dropping nozzle is relatively driven in the X, Y and Z directions with respect to the first substrate 3. Accordingly, a liquid crystal which is a liquid substance is dropped/supplied into a region of the inner surface of the first substrate 3 surrounded with the sealing agent 5 in a predetermined arrangement pattern, for example, in a matrix form.

The first substrate 3 on which the liquid crystal has been dropped is supplied to a bonding device 11. The second substrate 4 is supplied to the bonding device 11 together with the first substrate 3. Moreover, the first and second substrates 3, 4 are positioned as described later and bonded to each other. Accordingly, as shown in FIG. 6, a liquid crystal display panel P is assembled in which the liquid crystal 8 is filled between a pair of substrates 3, 4.

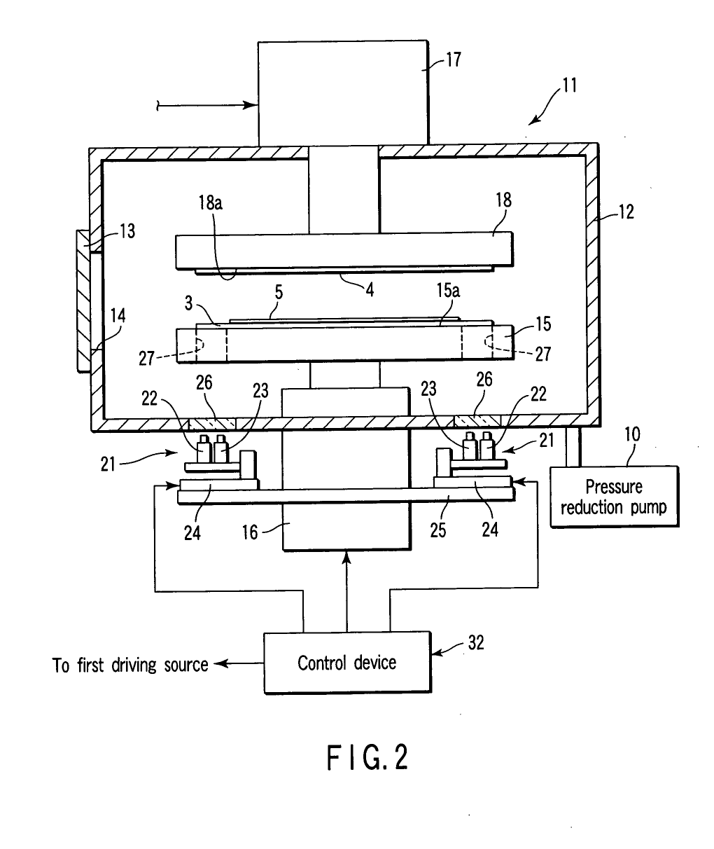

The bonding device 11 includes a chamber 12 as shown in FIG. 2. A pressure in the chamber 12 is reduced to a predetermined pressure, for example, of about 1 Pa by a pressure reduction pump 10. An outlet/inlet port 14 opened/closed by a shutter 13 is formed on one side of the chamber 12, and the first substrate 3 and second substrate 4 are discharged/inserted via the outlet/inlet port 14.

A first holding table 15 is provided in the chamber 12. The first holding table 15 is driven in X, Y and θ directions by a first driving source 16. Onto the holding surface 15a (upper surface) of the table 15, the first substrate 3 is placed, with its inner surface turned upwards. The inner surface (which will contact the second substrate 4) has been applied with the sealing agent 5 and the drops 8 of liquid crystal. The outer surface (lower surface) of the first substrate 3 supplied onto the holding surface 15a is held by the holding surface 15a with a predetermined holding force, for example, by vacuum absorption or the like.

A second holding table 18 driven in a Z direction in which the table is attached to/detached from the first holding table 15 by a second driving source 17 is disposed above the first holding table 15. The outer surface (upper surface) of the second substrate 4 is brought into contact with a holding surface 18a which is the lower surface of the second holding table 18, and held by an electrostatic force. It is to be noted that the first holding table 15 and second holding table 18 constitute a holding device.

As described later, when the pressure inside the chamber 12 is reduced with the pressure reduction pump 10, the holding force of the first substrate 3 by vacuum adsorption is smaller than that of the second substrate 4 by a static electricity. It is to be noted that a spacer S is formed on the inner surface (lower surface) of the second substrate 4 as shown in FIG. 6.

Images of four corner portions of the first substrate 3 held by the holding surface 15a of the first holding table 15 and the second substrate 4 held by the holding surface 18a of the second holding table 18 are picked up by four image pickup devices 21 (only two devices are shown) disposed below the chamber 12. Each image pickup device 21 includes a first image pickup camera 22, and a second image pickup camera 23 having an image pickup magnification higher than that of the first image pickup camera 22.

The first and second image pickup cameras 22, 23 of each image pickup device 21 are driven in the X, Y and Z directions by positioning devices 24 each including X, Y and Z tables, and each positioning device 24 is disposed on a laying plate 25 disposed under the chamber 12.

The bottom wall of the chamber 12 has a transparent window 26 made in at least the portion that opposes each positioning device 24. That part of the first holding table 25 (provided in the chamber 12) which corresponds to the transparent window 26 has a hollow portion 27. Via the hollow portions 27, the first and second image pickup cameras 22, 23 are capable of picking up the images of four corner portions of the first substrate 3 held by the holding surface 15a of the first holding table 15 and four corner portions of the second substrate 4 held on the holding surface 18a of the second holding table 18 via the first substrate 3.

A rough positioning mark and precise positioning mark (not shown) are disposed on the four corner portions of the first and second substrates 3, 4 outside the sealing agent 5. When the rough positioning marks of the respective substrates 3, 4 are aligned, the first and second substrates 3, 4 can be roughly positioned. When the precise positioning marks of the respective substrates are aligned, a pair of substrates 3, 4 can be positioned precisely.

It is to be noted that the hollow portions 27 are formed in the first holding table 15 in order to pick up the images of the first and second substrates 3-, 4, but the whole first holding table 15 may also be formed of transparent material without forming the hollow portions 27.

As shown in FIG. 3, image pickup signals of four sets of first and second image pickup cameras 22 and 23 (only one set is shown in FIG. 3) are input in an image processing unit 31 and converted into coordinate signals. The coordinate signals converted by the image processing unit 31 are input into a calculation processing section 33 disposed in a control device 32. This calculation processing section 33 calculates a relative positional shift amount between the substrates 3, 4 in the X, Y, and θ directions from coordinates of each pair of rough positioning marks or precise positioning marks of four corner portions of each of the first and second substrates 3, 4 whose images are picked up by four sets of first and second image pickup cameras 22 and 23.

When the positional shift amount between a pair of substrates 3, 4 is calculated by the calculation processing section 33, the positional shift amount is stored in a storage section 34, and is also output to a driving section 35. Accordingly, the driving section 35 outputs a driving signal to the first driving source 16 for driving the first holding table 15, and the first holding table 15 is driven in the X, Y, and θ directions to position the first and second substrates 3 and 4.

The first and second substrates 3 and 4 are positioned by rough positioning based on an image pickup signal from the first image pickup camera 22 and precise positioning based on the image pickup signal from the second image pickup camera 23.

The rough positioning is performed in a state in which the second substrate 4 is disposed apart from the first substrate 3 at a predetermined interval, and the precise positioning is performed in a state in which the second substrate 4 contacts the first substrate 3 via the sealing agent 5. When the precise positioning is performed, the spacer S is protruded from the inner surface of the second substrate 4.

Therefore, the frictional resistance between the spacer S and the first substrate 3 is larger than the holding force of the first and second substrates 3, 4, and these substrates 3, 4 shift. In this embodiment, the first substrate 3 is vacuum-adsorbed by the holding surface 15a of the first holding table 15. Therefore, when the pressure inside the chamber 12 is reduced, the holding force of the first substrate 3 drops. Accordingly, the first substrate 3 sometimes shifts on the holding surface 15a of the first holding table 15 by the frictional resistance.

Then, when the positional shift amount of the first substrate 3 from the second substrate 4 is obtained by the image pickup signal of the second image pickup camera 23, a correction movement amount for moving the first substrate 3 by the first holding table 15 is set to a value obtained by multiplying the positional shift amount by a correction coefficient K larger than 1 to perform the positioning. A drop in positioning precision with the shift of the first substrate 3 with respect to the first holding table 15 by the frictional resistance is compensated.

For example, when the positional shift amount between the first substrate 3 and the second substrate 4, obtained by the second image pickup camera 23, is δn (μm), the positioning is performed assuming that the correction movement amount of the first holding table 15 is M (μm) based on the positional shift amount δn. Thereafter, the positional shift amount is measured by the second image pickup camera 23 again. Then, when the positional shift amount is δm (μm), the correction coefficient K is set as follows:

K=f(S) Equation (1)

It is to be noted that S=M/(δn−δm)

That is, the calculation processing section 33 calculates the value obtained by multiplying the positional shift amount of the first and second substrates 3, 4 obtained by the image pickup signal of the second image pickup camera 23 by the correction coefficient K, and the driving signal is outputted to the first driving source 16 from the driving section 35 based on a calculation result.

When the precise positioning is performed several times, the positional shift amount of a pair of substrates 3, 4 calculated by the calculation processing section 33 after picking up the image by the second image pickup camera 23 is stored in the storage section 34.

Therefore, the correction coefficient K can be calculated based on Equation (1) using the previous positional shift amount δn stored in the storage section 34 every time the precise positioning is performed.

It is to be noted that the driving section 35 of the control device 32 also outputs the driving signal to the second driving source 17 and the positioning device 24.

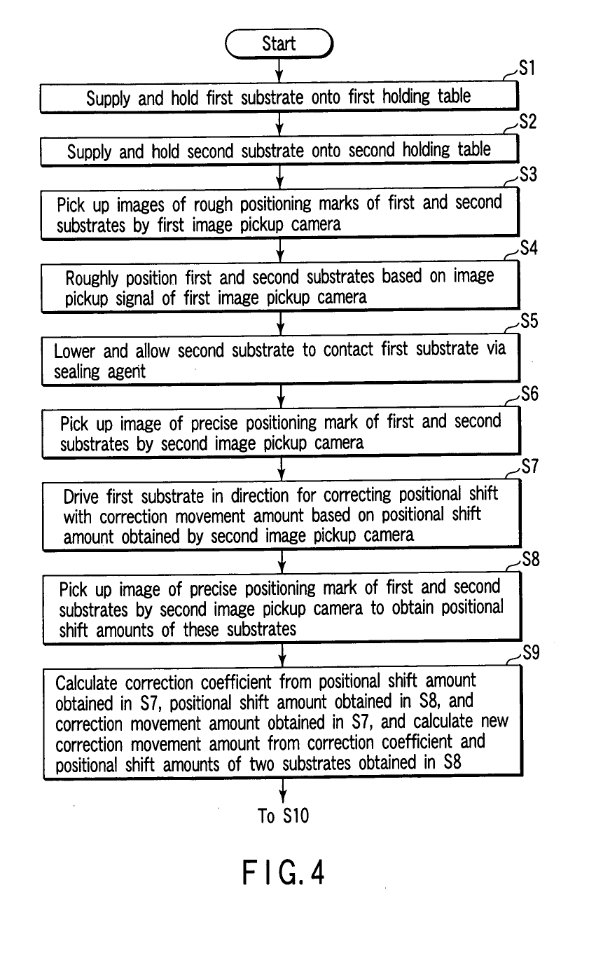

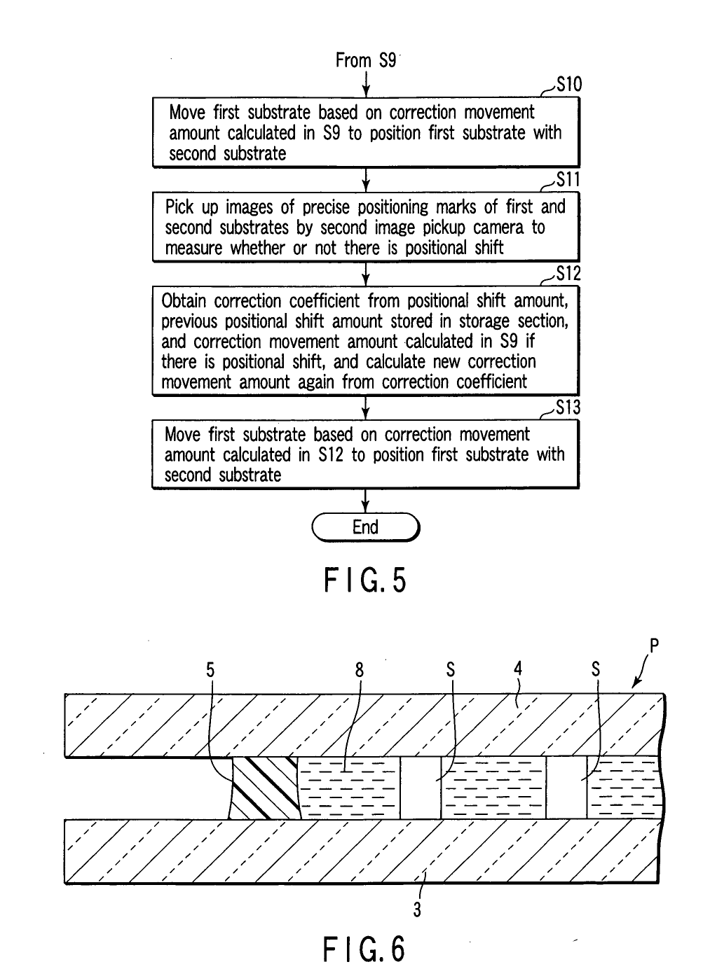

Next, a step of bonding the first substrate 3 to the second substrate 4 by the bonding device 11 constituted as described above will be described with reference to flowcharts of FIGS. 4 and 5.

First, in Step 1 the first substrate 3 is supplied into the chamber 12 of the bonding device 11 by a robot (not shown) and adsorbed/held by the holding surface 15a of the first holding table 15. In Step 2, the second substrate 4 is supplied into the chamber 12, and adsorbed/held by the holding surface 18a of the second holding table 18. When the second holding table 18 holds the second substrate 4, the second holding table 18 lowers to a predetermined height, and thereafter the pressure reduction pump 10 operates to reduce the pressure in the chamber 12. It is to be noted that the shutter 13 is closed before operation of the pressure reduction pump 10.

When the pressure in the chamber 12 is reduced to a predetermined pressure, in Step 3, the rough positioning marks disposed in four corner portions of the first substrate 3 and those of the second substrate 4 are picked up by the first image pickup camera 22. The image pickup signal of the first image pickup camera 22 is converted to a digital signal by the image processing unit 31, and thereafter input into the calculation processing section 33. Accordingly, the positional shift amount between the first and second substrates 3 and 4 is calculated.

In Step 4, the driving signal is output to the first driving source 16 from the driving section 35 based on the positional shift amount calculated by the calculation processing section 33, and the first holding table 15 is driven in the θ, X, and Y directions. Accordingly, the first substrate 3 is roughly positioned with respect to the second substrate 4.

In Step 5, subsequently to the rough positioning in Step 4, the second holding table 18 is driven in a lowering direction (approaching direction), and the second substrate 4 contacts the first substrate 3 held on the first holding table 15 via the sealing agent 5. In Step 6, the images of the precise positioning marks of four corner portions of the first and second substrates 3, 4 brought into contact with each other via the sealing agent 5 are picked up by the second image pickup camera 23 having a high magnification. At this time, the second image pickup camera 23 is positioned in a position where the image of the precise positioning mark can be picked up by the positioning device 24.

In the control device 32, the positional shift amount between the first substrate 3 and second substrate 4 is obtained by the image pickup signal of the second image pickup camera 23, and in Step 7 the first substrate 3 is driven in a direction in which the positional shift is eliminated by the correction movement amount in accordance with the positional shift amount obtained by the second image pickup camera 23. In this case, since the spacer S formed in the second substrate 4 slide-contacts the first substrate 3, the first substrate 3 receiving a held force smaller than that applied the second substrate 4 sometimes shifts in a direction reverse to a moving direction of the first holding table 15 on the holding surface 15a of the first holding table 15 by a frictional force.

Therefore, when first precise positional shift correction is performed in Step 8, the images of the precise positioning marks of the first and second substrates 3, 4 are picked up by the second image pickup camera 23 again to measure the positional shift amount of these substrates 3, 4.

When the positional shift amount is measured from the image pickup signal obtained by the second image pickup camera 23 in Step 8, the correction coefficient K is obtained based on the positional shift amount to calculate a new correction movement amount M by the correction coefficient K in Step 9.

For example, assuming that the positional shift amount (previous shift amount) δn before the correction is 5 μm, the first correction movement amount M is set to 5 μm to correct the positional shift amount of the first substrate 3, and the existing positional shift amount δm measured after the correction is 4 μm, the correction coefficient K is:

K=5/(5−4)=5.

Therefore, since the next (second) correction movement amount M indicates a value obtained by multiplying the positional shift amount measured after the first correction by the correction coefficient K, the correction movement amount M is:

M=4×5=20 (μm).

In Step 10, a second correction movement is performed. In the second correction movement, the first substrate 3 is moved based on the correction movement amount M calculated in Step 9. That is, the positional shift amount of the first and second substrates 3 and 4 is 4 μm at a second precise positioning time, whereas the positioning is performed with a correction movement amount of 20 μm.

Even at the second precise positioning time, the first substrate 3 shifts on the first holding surface 15a due to the frictional resistance with the spacer S formed in the second substrate 4. However, since the correction movement amount M of the first substrate 3 is set to a value for compensating for the shift amount of the first substrate 3 shifting on the first holding surface 15a at the precise positioning time, the first substrate 3 can be positioned with respect to the second substrate 4 with high precision.

When the first substrate 3 is theoretically corrected/moved with the correction movement amount M obtained in Step 9, it is possible to position the first and second substrates 3, 4 with high precision. However, when the first substrate 3 is corrected only twice in accordance with various conditions, the positioning precision with respect to the second substrate 4 is not sufficiently obtained in some cases.

Then, in Step 11, after performing the second positioning, the images of the precise positioning marks of the first and second substrates 3, 4 are picked up again by the second image pickup camera 23, and measurement is performed to judge whether or not there is a positional shift between these substrates 3, 4.

If there is a positional shift, the correction coefficient K is obtained again from the positional shift amount δn obtained at the previous measuring time (second measurement) and stored in the storage section 34 of the control device 32 in Step 12, the positional shift amount δm by the present measurement (third), and the previous correction movement amount M, and the first substrate 3 is moved by a correction movement amount M1 obtained by multiplying the correction coefficient K by the positional shift amount δm measured a third time to perform the positioning.

For example, if the third positional shift amount δm is 1 μm, the previous positional shift amount δn is 4 μm, and the previous correction movement amount M is 20 μm. Then, the present correction coefficient K is:

K=20/(4−1)≈6.67.

Therefore, the third correction movement amount M is:

M=1×6.67≈6.67 (μm)

In Step 13, the first substrate 3 is moved based on the correction movement amount M calculated in Step 12. Accordingly, it is possible to precisely position the first and second substrates 3 and 4.

Additionally, in the third precise positioning, the positional shift amount to be adjusted is 1 μm, and this is smaller than the second positional shift amount of 4 μm. However, since the present correction movement amount M of the first holding table 15 is about 6.67 times the positional shift amount of 1 μm, it is possible to securely move the first substrate 3 in a predetermined direction even with a small positional shift amount of the first substrate 3.

To position the first and second substrates 3 and 4 more precisely, the above-described steps may be repeated several times, but it is possible to position the substrates with high precision by repeating the precise positioning twice. However, if the positioning is performed three times, a higher position precision can further be obtained.

That is, since the positional shift amount calculated by the calculation processing section 33 is stored in the storage section 34 of the control device 32, it is possible to calculate the correction coefficient K using the previous positional shift amount δn stored in the storage section 34.

It is to be noted that even when the precise positioning is performed twice or more, a step of confirming whether or not there is a positional shift in the first and second substrates 3 and 4 by the second image pickup camera 23 may also be disposed after finally performing the precise positioning.

The first substrate 3 contacts the second substrate 4 via the sealing agent 5 formed of a viscoelastic agent. Therefore, even when the first substrate 3 is shifted by a predetermined amount and positioned, the first substrate 3 returns in a direction reverse to the moving direction by a restoring force of the sealing agent 5, and the shift sometimes occurs.

Therefore, when the sealing agent 5 sometimes returns by elasticity, the correction movement amount at the precise positioning time is set to a value for compensating for the shift generated by the return of the sealing agent 5. For example, when the correction coefficient is obtained by Equation (1), a return amount of the sealing agent 5 due to elasticity may be added to the present shift amount δm. Then, when the positioned first substrate 3 returns by the elasticity of the sealing agent 5, the first and second substrates 3 and 4 can be positioned precisely.

When the precise positioning is performed, the first substrate 3 sometimes shifts in the direction reverse to the moving direction of the first holding table 15 on the holding surface 15a of the first holding table 15 as described above. When the first substrate 3 shifts, it is supposed that the precise positioning mark formed in the first substrate 3 deviates from a field of view of the second image pickup camera 23.

Therefore, to precisely position the first and second substrates 3 and 4, the first holding table 15 is moved by the predetermined correction movement amount M, while the second image pickup camera 23 is moved by the positioning device 24 supported movably in the X, Y and Z directions so as to position the precise positioning mark of the second substrate 4 held by the second holding table 18 in a view field center of the second image pickup camera 23. In this manner, after completing the movement of the holding table 15 with correction movement amount M, a region having at least a size of half of a view field range of the image pickup camera 23 exists around the precise positioning mark of the second substrate 4 in the view field region of the second image pickup camera 23. Additionally, after the holding table 15 completes the movement by the correction movement amount M, a relative distance between the precise positioning marks of two substrates 3, 4 is shorter than that before the movement of the holding table 15 by the correction movement amount M. Therefore, the precise positioning marks of two substrates 3, 4 positioned in the view field range of the second image pickup camera 23 can be prevented from deviating from the view field range after the movement by the correction movement amount M as much as possible.

In the above-described embodiment, the correction coefficient for setting the correction movement amount of the first substrate is obtained by the previous correction movement amount of the substrate, the previous positional shift amount of two substrates, and the present positional shift amount of two substrates after moving the first substrate by the previous correction movement amount.

However, when two substrates are bonded to each other under the same condition, first the correction coefficient is set. Subsequently, the correction movement amount may determined by the same correction coefficient to perform the positioning. That is, the correction coefficient does not have to be calculated every time as in the above-described embodiment, and may also be a preset value. It may be determined whether to calculate every correction coefficient or to use the set value in accordance with a quality or lot of the substrate. For example, with a substrate having a large thickness fluctuation, the frictional force applied between the substrates every time changes due to the influence of a fluctuation of the thickness of the substrate. Therefore, it is assumed that the correction coefficient is calculated every time. Conversely, with a substrate of a type having a small thickness fluctuation, since the frictional force exerted between the substrates is substantially constant, the correction coefficient may be the set value. Therefore, the coefficients may also be switched in accordance with the type or lot of the substrate for use.

In this manner, according to the first embodiment of the present invention, one of two substrates which contact each other via the sealing agent or the liquid substance is moved with a correction movement amount which is larger than the shift amount from the other substrate.

Therefore, even when the shift is generated between either substrate and holding means by the frictional resistance with the other substrate, the shift amount is compensated, and it is therefore possible to quickly and precisely position two substrates.

The present embodiment is an example in which the positional shift amount between the first and second substrates 3, 4 is multiplied by the obtained correction coefficient K as it is. However, instead, a lower limit and an upper limit, or either is set to the correction coefficient K. When the obtained correction coefficient K is smaller than the lower limit, or larger than the upper limit, the correction coefficient K may also be used as the lower limit or the upper limit.

For example, when the lower limit of the correction coefficient K is set to “3”, and the upper limit is set to “8”, and when the obtained correction coefficient is K=5, the correction coefficient K is between the upper and lower limits, and therefore K=5 is used as it is. When the obtained correction coefficient is K=2, the correction coefficient K is smaller than the lower limit, and therefore K=3 is set. When the obtained correction coefficient is K=10, the correction coefficient K is larger than the upper limit, and therefore K=8 is set.

In this case, the following can be prevented: the correction coefficient K is excessively small, and the shift amount by which the first substrate 3 shifts on the holding surface 15a of the first holding table 15 at a precise positioning time cannot be compensated; and, conversely, the correction coefficient K is excessively large, the first substrate 3 is excessively moved with respect to the second substrate 4 by the shift amount between the first substrate 3 and the holding surface 15a or more, and the positional shift amount between the first and second substrates 3, 4 is increased.

Either the preset correction coefficient or the correction coefficient calculated using Equation (1) may be selected in accordance with the shift amount between the first and second substrates 3, 4.

For example, a threshold value is set beforehand. When the positional shift amount is larger than the threshold value, the correction coefficient stored beforehand in the storage section 34 is used. When the positional shift amount is not more than the threshold value, the correction coefficient is calculated using Equation (1) and used.

That is, with the increase of the correction movement amount of the first substrate 3 with respect to the second substrate 4, a ratio of the increase of the positional shift amount between the first substrate 3 and the holding surface 15a of the first holding table 15 sometimes decreases, and this is confirmed by experiments.

In this case, for example, when the first substrate 3 is moved with respect to the second substrate 4 by a correction movement amount of 5 μm, a shift amount of 4 μm is generated between the first substrate 3 and the holding surface 15a, and the first substrate 3 moves only by about 1 μm with respect to the second substrate 4. However, when the first substrate 3 is moved by a correction movement amount of 30 μm with respect to the second substrate 4, the positional shift amount between the first substrate 3 and the holding surface 15a is about 5 μm, and the first substrate 3 moves by about 25 μm with respect to the second substrate 4.

Therefore, when the positional shift amount between the first and second substrates 3, 4 is about 30 μm, and when the correction coefficient K obtained using Equation (1) is “3” or “4”, the first substrate 3 is moved by the correction movement amount calculated using this correction coefficient K with respect to the second substrate 4, as a result, the first substrate 3 is possibly corrected/moved more than necessary with respect to the second substrate 4.

Then, the threshold value (e.g., 20 μm) is set with respect to the positional shift amount between the first and second substrates 3, 4. When the positional shift amount exceeds the threshold value, the correction movement amount is calculated using the correction coefficient K (e.g., K=1.2) stored beforehand in the storage section 34.

In this manner, even in the above-described case, a disadvantage that the first substrate 3 is corrected/moved with respect to the second substrate 4 more than necessary is prevented, and the positioning can be quickly performed.

It is to be noted that the calculation processing section 33 of the control device 32 is capable of calculating the positional shift amount between the first and second substrates 3, 4, comparing the positional shift amount with the threshold value, and selecting the use of the set correction coefficient or the correction coefficient by Equation (1) based on a comparison result.

As another example for obtaining the correction coefficient K, there is the following method. That is, in the method, the correction coefficient K is obtained based on data obtained from a plurality of past coefficients. The data includes the correction coefficient, the shift amount between the first and second substrates 3, 4, the correction movement amount for positioning the first substrate 3 with respect to the second substrate 4, and the like.

For example, with the use of the past five data, the same procedure as that of the above-described embodiment is used until the number of positioning times between the first and second substrates 3, 4 is six. That is, the positioning is performed for the first time without using any correction coefficient. Moreover, in and after seventh positioning, every time the positional shift between the first and second substrates 3, 4 is measured, the new correction coefficient is obtained by the same procedure as that of the above-described embodiment. Moreover, an average value of the correction coefficients is calculated using the correction coefficient and the past five correction coefficients before the present coefficient, and the correction movement amount may be calculated using an average value of the calculated correction coefficients.

It is to be noted that in the first embodiment, an example in which a numeric value larger than 1 is used as the correction coefficient K has been described, but a numeric value smaller than 1 may also be used.

That is, when the substrate is held by the holding table via the elastic member, the elastic member is sometimes elastically deformed in a horizontal direction as a positioning direction by the frictional resistance by the sealing agent, liquid crystal or the like between the substrates at a time when two substrates are positioned. Moreover, a restoring force is generated in the deformed elastic member, and this restoring force acts during the positioning of the opposite substrates.

Therefore, when the positioning is repeated a plurality of times, the deformation of the elastic member is accumulated, and additionally the correction movement amount between the substrates is reduced, the opposite substrates relatively move by the restoring force of the elastic member, and the substrate also relatively moves by the correction movement amount or more from the completion of the first positioning until the positional shift between the substrates is detected again. Moreover, when the opposite substrates relatively move by the correction movement amount or more in this manner, the correction coefficient obtained by Equation (1) is a numeric value smaller than 1.

Moreover, in consideration of the above, the threshold value is set to the number of positioning times between the substrates or the positional shift amount between the substrates. When the number of positioning times exceeds the threshold value, or when the positional shift between the substrates is not more than the threshold value, the correction coefficient smaller than 1, set beforehand in the storage section or the like, may also be used.

In the above-described embodiment, the measurement is performed to check whether or not there is a positional shift between the substrates 3, 4 upon every completion of the positioning between the first and second substrates 3, 4, but the measurement may also be performed to check whether or not the positional shift between the substrates 3, 4 deviates from a preset permissible value regardless of whether or not there is a positional shift. Only when the positional shift exceeds the permissible value is the positioning performed again.

In the above description, the first substrate 3 is positioned with respect to the second substrate 4, but the positioning of the first and second substrates 3, 4 is relative. Therefore, the second substrate 4 may also be positioned with respect to the first substrate 3.

In the above-described embodiment, an example of positional shift correction in the positioning performed in a state in which the frictional force is exerted in the positioning direction between two substrates by the spacer has been described. However, the present invention is also applicable to the positioning in a state in which two substrates contact each other only via the liquid crystal or in a state in which two substrates are superposed into contact with both the liquid crystal and the sealing agent. In short, the present invention is applicable as long as the positioning is performed in a state in which the frictional force in the positioning direction is exerted between two substrates.

Moreover, in the above-described embodiment, the liquid crystal is dropped onto the first substrate beforehand, and the first substrate is bonded to the second substrate in the chamber whose pressure has been reduced. Alternatively, the present invention is also applicable to a case where after bonding two substrates to each other under atmospheric pressure, the liquid crystal is injected into a gap between the substrates to manufacture a liquid crystal display panel.

Furthermore, the image processing unit is disposed separately from the control device, but may also be disposed in the control device.

Additionally, the first substrate is held onto the first holding table by vacuum adsorption, but may also be held only by the frictional force between the holding surface of the first holding table and the first substrate.

Moreover, since two substrates are bonded to each other in a chamber under vacuum reduced pressure, the holding force of the first substrate vacuum-adsorbed at the bonding time is lowered, and the first substrate shifts on the first holding table. However, when the opposite substrates are held by an electrostatic force and a substantially equal holding force, either substrate shifts at a positioning time. However, even when either substrate shifts, a relative shift amount becomes equal. Therefore, when the correction movement amount is calculated based on the positional shift amount, high-precision positioning is possible in the same manner as in the above-described embodiment.

It is to be noted that when the holding force of either substrate is set to be smaller than that of the other substrate, it is possible to specify the substrate which shifts at the positioning time.

Moreover, a two-substrate example in which the first substrate is bonded to the second substrate has been described, but the present invention is not limited to this, and the present invention is also applicable to a case where one or more substrates are further bonded to two bonded substrates using the sealing agent in a state in which the liquid crystal is charged between the substrates.

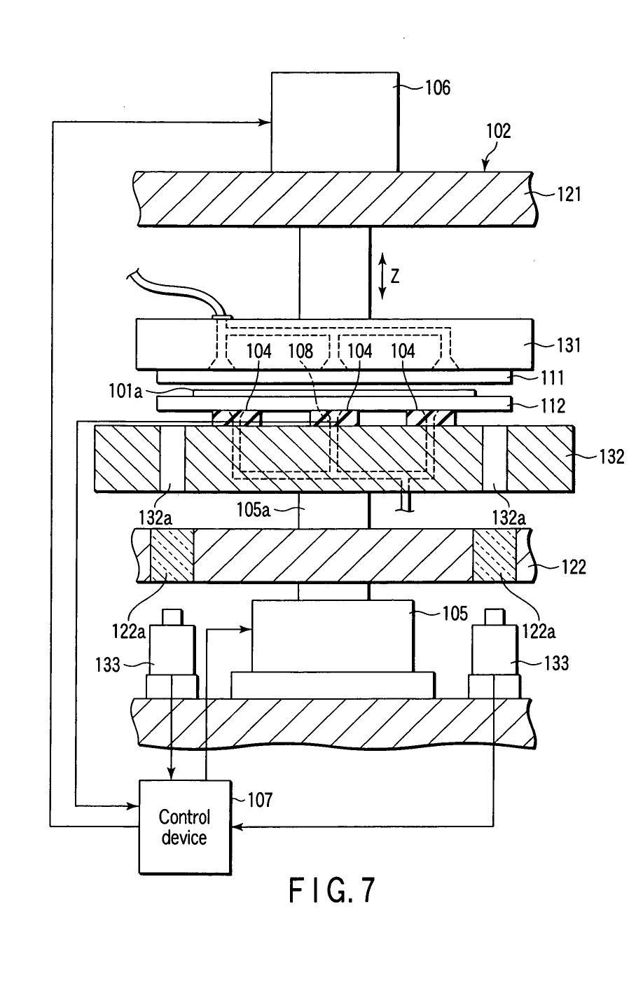

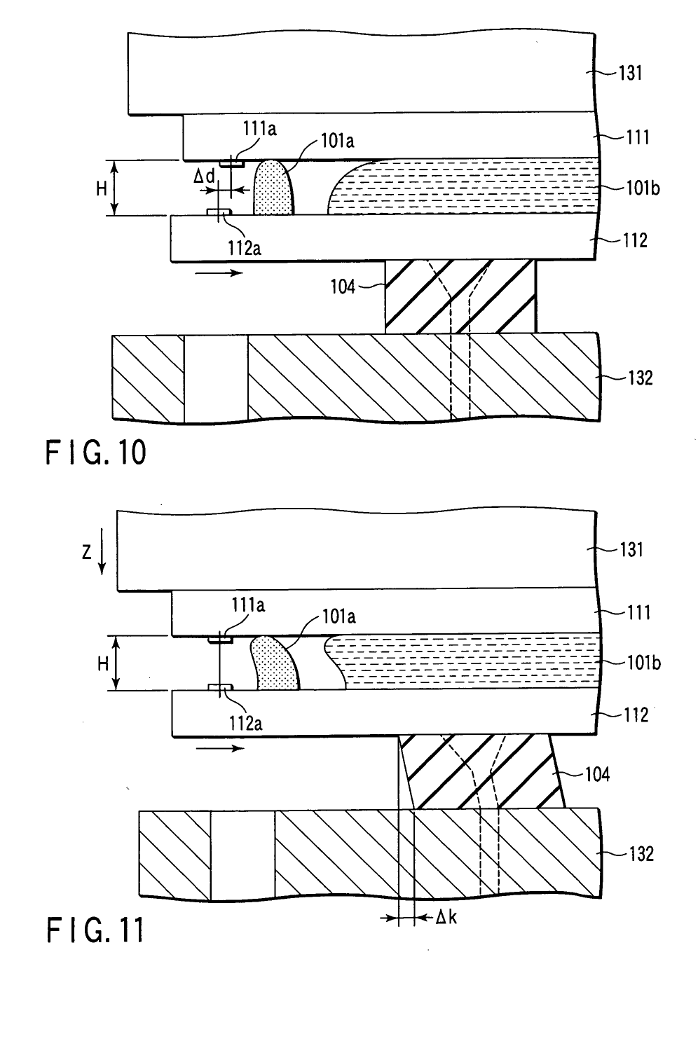

FIGS. 7 to 14 show a second embodiment of the present invention, and FIG. 7 is a main part front view showing the apparatus for bonding the substrates. FIG. 10 is an enlarged sectional view of a main part, showing a state in which both the upper/lower substrates are superposed, and the upper substrate is allowed to contact the adhesive applied to the lower substrate so as to position the respective substrates with high precision based on alignment marks formed on the respective substrates.

As shown in FIG. 7, an upper substrate 111 corresponding to the second substrate and a lower substrate 112 corresponding to the first substrate which are to be bonded to each other are disposed facing each other in a vacuum tank 102 corresponding to a chamber, including an upper lid 121 and a lower lid 122. The upper substrate 111 is adsorbed/held on the undersurface of an upper stage (upper board) 131, and the lower substrate 112 is laid on and adsorbed/held on a lower stage (lower board) 132 corresponding to the first holding table.

A uniform gap must be provided between the substrates 111 and 112 so that these substrates may be bonded together in a desired way. To provide a uniform gap, the mutually facing surfaces of the substrates 111 and 112 should be flat, not undulated. The substrates 111 and 112 are pressed to each other and boded together, with adhesive 101a (corresponding to a sealing layer) applied between them.

The upper substrate 111 is directly adsorbed/held by the upper stage 131, but the lower substrate 112 is adsorbed/held on the lower stage 132 via a plurality of, for example, five elastic members 104 so as to absorb concave/convex portions of the surfaces of both the upper/lower stages 131, 132 and to avoid an adhesive defect in the adhesive 101a because of the concave/convex portion.

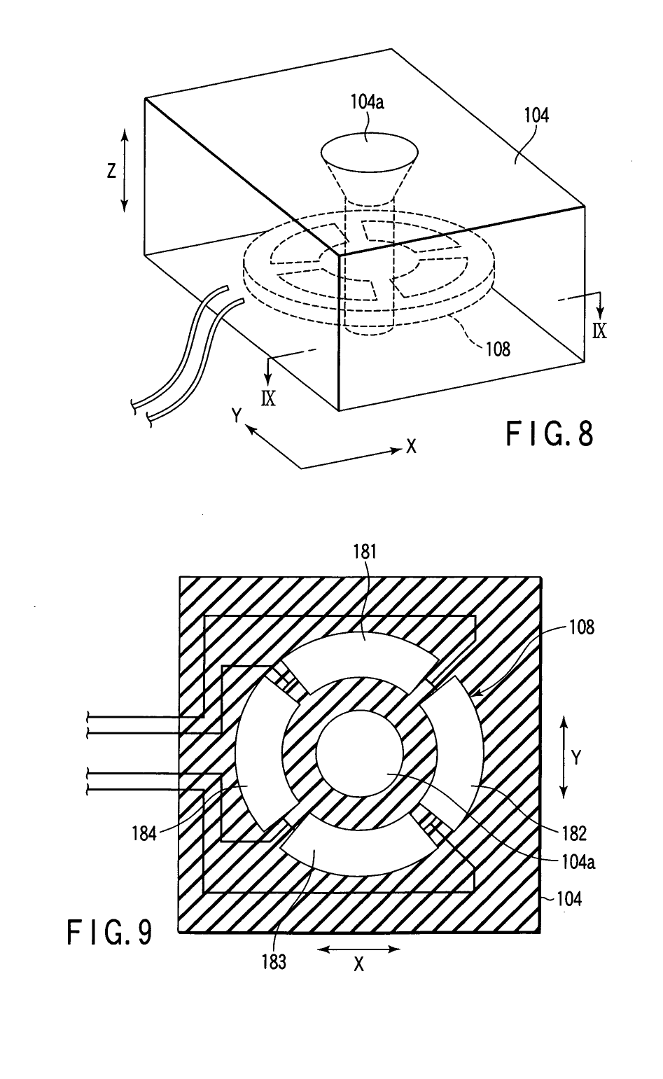

As shown in an enlarged perspective view in FIG. 8, all five elastic members 104 have a flat tetragonal shape, and an exhaust hole 104a for a suction chuck connected from the lower stage 132 and opened is constituted to adsorb the lower substrate 112 laid on the elastic member 104. Moreover, as shown in FIG. 8, a known strain gauge 108 is built in the elastic member 104 which adsorbs/holds the middle portion of the lower substrate 112. When the elastic member 104 itself receives a mechanical external force and is deformed in a horizontal direction, the strain gauge 108 having flexibility detects a change amount of the elastic member 104 in the horizontal direction, and is connected to a control device 107 so as to supply detected data to the control device as shown in FIG. 7.

FIG. 9 is a plan view showing the elastic member 104 shown in FIG. 8, cut in an arrow direction from a IX-IX line, and the built-in strain gauge 108 viewed from above.

A sensor described, for example, in Jpn. Pat. Appln. KOKAI Publication No. 6-397350 is applicable to the strain gauge 108 of the present embodiment. That is, for the strain gauge 108, four electrode bodies 181, 182, 183, 184 forming pairs via pressure-sensitive resistance bodies in a vertical (Z-axis) direction are arranged at an interval of 90 degrees. The strain gauge converts a mechanical moment received around X and Y-axes in the horizontal direction with the deformation of the elastic member 104 to a voltage value to supply an output to the control device 107.

It is to be noted that the lower stage 132 on which the elastic members 104 are mounted is supported by an X-Y-θ movement mechanism 105 corresponding to a first driving mechanism via a shaft 105a, and moved in a horizontal plane so that a relative position between the upper/lower substrates 111, 112 is adjustable.

It is to be noted that in this second embodiment, the strain gauge 108 is built in the elastic member 104 in the middle portion of the lower substrate 112, but the strain gauges 108 may also be built in all the elastic members 104 disposed in four corner portions including the middle portion or the optional elastic member 104 selected from a plurality of elastic members 104.

Then, in the positioning of the facing substrates 111, 112, for example, after pre-alignment, first the control device 107 controls a pressing mechanism 106 corresponding to a second driving mechanism to lower the upper stage 121. As enlarged and shown in FIG. 10, the upper/lower substrates 111, 112 face each other in a small gap having an interval H, and the upper substrate 111 slightly contacts the adhesive 101a on the surface of the lower substrate 112. To achieve this state, the operation below is performed.

In a state shown in FIG. 10, image pickup apparatuses 133, 133 disposed below and corresponding to image pickup cameras photograph alignment (positioning) marks 111a, 112a of the respective substrates 111, 112 to supply photographed patterns to the control device 107. The image pickup apparatuses 133, 133 pick up the images of the positioning marks 111a, 112a through light windows 122a and through holes 132a in the same manner as in the first embodiment.

The control device 107 to which the photographed pattern has been supplied detects a positional shift amount Δd between the opposite substrates 111, 112 by recognition of the pattern. Moreover, the X-Y-θ movement mechanism 105 is appropriately driven/controlled in such a manner that the positional shift amount Δd is reduced in a preset permissible range, preferably close to zero, and the substrates are bonded with good precision.

At this time, as shown in FIG. 11, since the X-Y-θ movement mechanism 105 moves the lower substrate 112 against a contact resistance between the adhesive 101a, liquid crystal member 101b, or the like and the upper substrate 111, the elastic members 104 between the lower substrate 112 and the lower stage 132 are deformed by distance Δk in the horizontal direction, the deformation of this distance Δk is detected by the built-in strain gauge 108, and the detection signal is supplied to the control device 107.

It is to be noted that at this time, when there is no slippage between the lower substrate 112 and the elastic member 104, the control device 107 is capable of obtaining the shift amount between the lower stage 132 and the lower substrate 112 between the state shown in FIG. 10 and that shown in FIG. 11 based on the detection signal.

Next, the control device 107 drives/controls the pressing mechanism 106 to push down the upper stage 131 in a direction shown by an arrow Z in FIG. 11 (downwards), and accordingly both the upper/lower substrates 111, 112 are pressurized for a preset time. Therefore, an interval between the upper/lower substrates 111, 112 is further reduced.

Before the pushing-down of the upper stage 131 by the control device 107, the control device 107 drives the X-Y-θ movement mechanism 105 based on the detection signal of the deformation (distance Δk) from the strain gauge 108 to move/control the lower stage 132 in a direction in which the deformation of the elastic member 104 (distance Δk) is reduced.

Accordingly, as shown in FIG. 13, the deformation in an X-Y-θ surface of the elastic member 104 is eliminated.

That is, according to the second embodiment, the restoring force generated by the deformation of the elastic member 104 based on positioning adjustment (alignment) is eliminated or is largely decreased. Therefore, both the upper/lower substrates 111, 112 are bonded to each other maintaining a highly precisely positioned state without any positional shift by the restoring force of the elastic member 104 from when the positioning adjustment is completed to push down the upper stage 131 until the upper/lower substrates 111, 112 are released from both the upper/lower stages 131, 132.

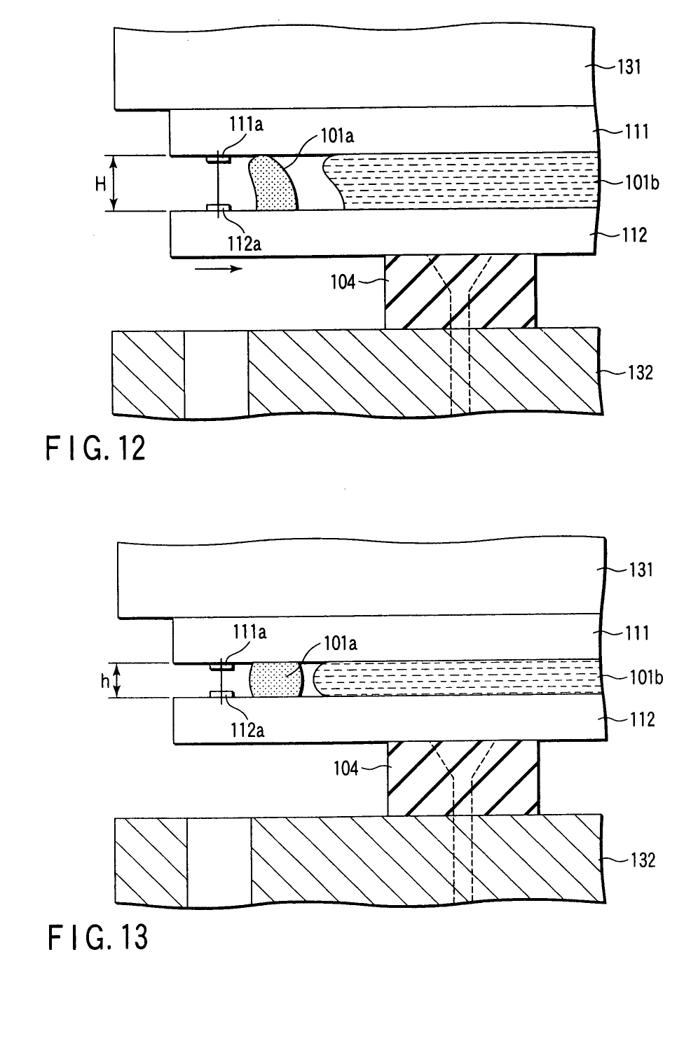

It is to be noted that in the second embodiment shown in FIG. 7, five elastic members 104 are mounted on the rectangular upper surface of the lower stage 132, and the strain gauge 108 is only built into the elastic member at the middle portion. However, the strain gauges 108 may also be built into all five elastic members 104. In this case, the control device 107 calculates, for example, an average value or a medium value of the respective deformation amounts detected by these strain gauges 108, and may move/control the stage in a direction in which the positional shift amount (distance Δk) of the horizontal direction (shown in FIG. 11 or 12) is reduced based on the average or medium value.

Moreover, the positioning in the horizontal direction (X-Y-θ direction) can be divided into the positioning in X-Y (orthogonal) direction and the positioning in θ (circling) direction.

In the positioning in the X-Y direction, since the deformation can be detected in the same direction (X-Y direction) in any elastic member 104, the control device 107 is capable of obtaining an operation amount with respect to the X-Y-θ movement mechanism 105 by simple calculations, such as the calculation of the average or middle value as described above.

On the other hand, in the positioning in the θ direction, the deformation of the elastic member 104 detected in a substrate central portion, which is a rotation center of the substrate in the X, Y direction, is remarkably small. Therefore, for example, the elastic members 104 in which the strain gauges 108 are built are also disposed in four corner portions of the substrate 112, and the shift amount between the lower stage 132 and the lower substrate 112 in the θ direction is geometrically obtained from the detected values of the deformation in the X-Y direction in the respective strain gauges 108 disposed in four corner portions. Accordingly, an operation amount may be obtained in a direction in which the deformation amounts of the elastic members 104 in four corner portions are reduced.

In the first embodiment, the deformation amount of the elastic member 104 by the positioning is detected by the strain gauge 108. The deformation amount of the elastic member 104 is a difference of a positional relation between the lower substrate 112 and the lower stage 132 shown in FIG. 10 from that between the lower substrate 112 and the lower stage 132 shown in FIG. 11.

That is, the strain elimination of the elastic member 104 means the returning of the positional relation between the lower substrate 112 and the lower stage 132 back to the state of FIG. 10 from that of FIG. 11.

Then, without disposing the strain gauges 108 in the elastic members 104, the positional shift amount after the positioning (generated as a result of the deformation of the elastic member 104) with respect to that before the positioning is detected between the lower substrate 112 and the lower stage 132 between which the elastic members 104 are vertically held, and the position of the lower stage 132 is controlled in a direction in which the detected value turns to zero. In this case also, the object of the present invention can be achieved.

Then, in a method of detecting the positional shift amount between the lower substrate 112 and lower stage 132 between which the elastic members 104 are held, for alignment marks 112a of the lower substrate 112 whose images are picked up by the image pickup apparatuses 133, 133, the control device 107 calculates the shift amount between the position on X-Y coordinate axis photographed in the state shown in FIG. 10 (before the positioning) and the position on the X-Y coordinate axis after the deformation of the elastic member 104 (by the positioning) as shown in FIG. 11 or 12. The X-Y-θ movement mechanism 105 may also be corrected/controlled based on the calculated amount.

Furthermore, in the embodiment, the lower stage 132 has been moved to eliminate the deformation of the elastic member 104, but the X-Y-θ movement mechanism may also be incorporated in the upper stage 131, and the upper stage 131 may be moved to move the upper substrate 111 with respect to the lower substrate 112.

Alternatively, the X-Y-θ movement mechanism may also be connected and incorporated in both the upper/lower stages 131, 132 to share the correction operation of the shift amount with respect to the elastic members 104. At this time, the elastic member 104 is attached to either or both of the upper/lower stages 131, 132, and the operation may be performed so as to return the deformation amounts of these elastic members 104 to zero at a bonding operation time.

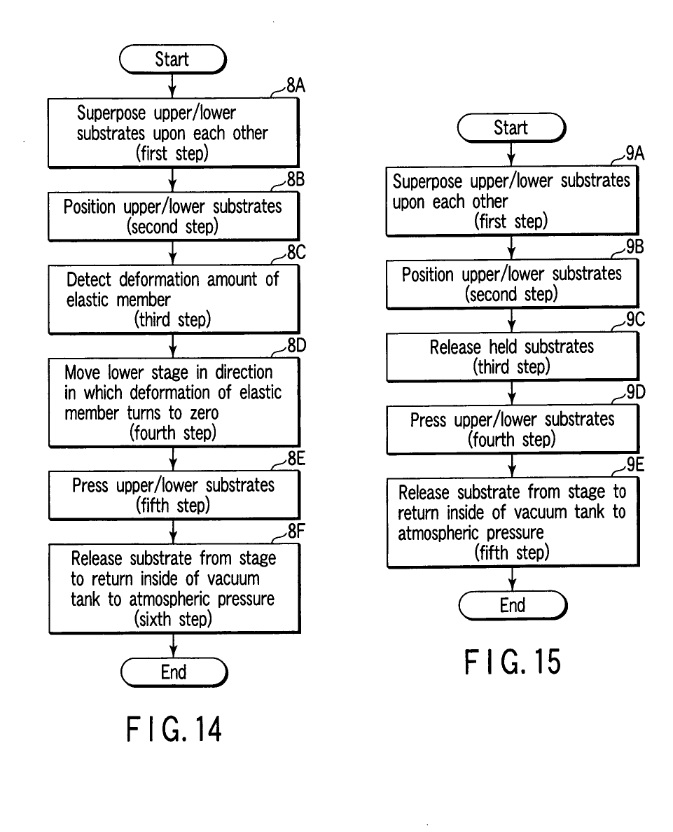

Next, a procedure (Steps) for bonding two substrates using the apparatus for bonding the substrates according to the second embodiment shown in FIG. 7 will be described hereinafter with reference to a flowchart shown in FIG. 14. It is assumed that both the upper/lower substrates 111, 112 are supplied into a vacuum tank 102, and adsorbed/held by both the upper/lower stages 131, 132, and the pressure in the vacuum tank 102 is reduced already in a vacuum state.

In a first step, the upper/lower substrates 111, 112 are superposed upon each other via the adhesive 101a (Step 8A).

In a second step, the positioning operation is performed in a direction in which the positional shift amount between the upper/lower substrates 111, 112 is reduced (Step 8B).

Next, in a third step, the deformation amount of the elastic member 104 generated by the positioning operation of the opposite substrates 111, 112 is detected (Step 8C).

Next, in a fourth step, the lower substrate 112 is moved/adjusted in a direction in which the deformation amount of the elastic member 104 turns to zero (Step 8D).

Thereafter, as a fifth step, the upper/lower substrates 111, 112 are further pressed for a preset time (Step 8E).

Furthermore, in a sixth step, both the upper/lower substrates 111, 112 are released from both the upper/lower stages 131, 132, and the inside of the vacuum tank 102 is returned to an atmospheric pressure (Step 8F).

After the inside of the vacuum tank 102 is returned to atmospheric pressure, the upper stage 131 is raised, and the bonded substrates 111, 112 are taken out of the vacuum tank 102 by a conveying robot (not shown), and are conveyed into the next steps such as a step of hardening the adhesive 101a.

It is to be noted that in the description of the procedure, after the moving/adjusting of the lower stage 132 (Step 8D), the adhesive 101a is further pressed to bond the upper/lower substrates 111, 112 to each other (Step 8E). In short, the method of bonding the substrates in the second embodiment is not limited as long as the restoring force of the elastic member 104 deformed during the positioning operation can be prevented from being exerted between the positioned substrates 111, 112.

Therefore, the operation may be performed until at least one of the adsorbing/holding of the upper substrate 111 by the upper stage 131 and that of the lower substrate 112 by the lower stage 132 is released. Even if Step 8D is executed during the Step 8E, the object is similarly attainable. Additionally, when the eliminating operation of the deformation of the elastic member 104 is performed as fast as possible, an effect of preventing the shift by the restoring force is enhanced. Therefore, the procedure is preferably the Step 8B→Step 8C→Step 8D, as described above.

Moreover, assuming that the upper substrate 111 contacts not only the adhesive 101a but also the liquid crystal 101b having viscosity or the spacer during the positioning operation of both the upper/lower substrates 111, 112, the elastic member 104 is deformed against the viscosity inherent in not only the adhesive 101a but also the liquid crystal 101b or the spacer, in addition to the contact resistance between the adhesive 101a or the liquid crystal member 101b and the upper substrate 111.

In other words, in the positioning operation of both the upper/lower substrates 111, 112, not only the elastic member 104 but also the adhesive 101a, and the liquid crystal member 101b or the like have the viscosity and are deformed.

Therefore, the control device 107 operates the X-Y-θ movement mechanism 105 to return the deformation amount Δk of the elastic member 104 itself to zero. Even when the positional shift amount between both the upper/lower substrates 111, 112 is apparently eliminated, it is also supposed that reaction caused by the viscosity of the adhesive 101a, liquid crystal member 101b or the like deformed during the positioning operation is exerted, which causes a new positional shift between both the upper/lower substrates 111, 112.

To avoid this phenomenon, the control device 107 may impose restrictions, for example, by multiplying by a coefficient σ (0<σ<1) the movement amount for eliminating the deformation amount Δk of the elastic member 104, in consideration of the reaction of the adhesive 101a or the like. The coefficient σ can be determined from the positional shift amount between the upper substrate 111 and the lower substrate 112 after reducing the deformation amount Δk of the elastic member 104. This has been obtained by an experiment.

Alternatively, during the positioning operation in which the X-Y-θ movement mechanism 105 is driven/controlled by the control device 107, the positioning operation is performed in consideration of the positional shift amount predicted by the reaction (restoring force) of the adhesive 101a, liquid crystal 101b or the like, that is, a return amount. For example, the return amount is added beforehand to perform the positioning operation. Accordingly, finally the bonding can be adjusted/controlled so that the bonding is completed with the positional shift amount in a permissible range in a micron or submicron order.

Next, in the second embodiment, it has been described that the control device 107 moves/adjusts the lower stage 132 (or the upper stage 131) to eliminate the deformation of the elastic member 104. Even when the connection between the lower substrate 112 and the lower stage 132 (or between the upper substrate 111 and the upper stage 131), that is, the adsorbing/holding of at least one of the substrates 111, 112 is temporarily cancelled, the substrate 111 or 112 is released from a restricted state of the deformation in the elastic member 104 or the like. Therefore, the object can similarly be achieved.

FIG. 15 shows the procedure (Steps) of the method of bonding the substrates according to a third embodiment of the present invention, in which the substrate holding is temporarily cancelled in order to eliminate the reaction caused by the deformation of the elastic member 104 or the like at the positioning operation time. It is to be noted that the apparatus for bonding the substrates using this method is different from the substrate bonding apparatus shown in FIG. 7 only in that the strain gauge 108 is not necessarily required in the elastic member 104, and the other constitution is the same. Therefore, the procedure will be described also with reference to the constitution of FIG. 7. It is assumed that both the upper/lower substrates 111, 112 are supplied into the vacuum tank 102 and adsorbed/held by both the upper/lower stages 131, 132, and the pressure in the vacuum tank 102 is reduced already in the vacuum state.

That is, first, in a first step, the upper/lower substrates 111, 112 are superposed upon each other via the adhesive 101a (Step 9A).

In a second step, the positioning operation is performed in such a manner that the positional shift amount between the upper/lower substrates 111, 112 is reduced (Step 9B).

Next, in a third step, for at least one of the substrates 111, 112, the adsorbing/holding with respect to the stage is released (Step 9C).

Next, in a fourth step, the released substrate is adsorbed/held again by the stage, and the upper/lower substrates 111, 112 are further pressed for a preset time (Step 9D). When the released substrate is adsorbed/held again, and the opposite substrates 111, 112 are pressed in this manner, the positional shift can be prevented from being caused between the opposite substrates 111, 112 by the pressing.

Furthermore, in a fifth step, both the upper/lower substrates 111, 112 are released from both the upper/lower stages 131, 132, and the inside of the vacuum tank 102 is returned to atmospheric pressure (Step 9E). After the inside of the vacuum tank 102 is returned to atmospheric pressure, the upper stage 131 is raised, and the bonded substrates 111, 112 are taken out of the vacuum tank 102 by the conveying robot (not shown), and are conveyed for a subsequent process step, such as the step of hardening the adhesive 101a.

As described above, during the execution of the third step (Step 9C), the control device 107 executes controls such as the controlling of an exhaust pump connected to each adsorption hole, and the temporary releasing of an electrostatic chuck, in order to release the adsorbing or the holding of the stage (at least one of the stages 131 and 132) with respect to the positioned substrates 111, 112. When at least one of the bindings between the opposite stages 131, 132 and the opposite substrates 111, 112 is released, the binding with respect to the elastic member 104 is released. Therefore, the deformation of the elastic member 104 by the positioning operation is released, and the deterioration of the positioning precision between the opposite substrates 111, 112 caused by the restoring force of the elastic member 104 can be avoided.

It is to be noted that in the third embodiment, after the cancellation of the adsorption or the like, the frictional resistance between the separated upper stage 131 and upper substrate 111 is smaller than that between the lower substrate 112 and the elastic member 104 on which the lower substrate is laid. Therefore, when the holding of the substrate 111 is released on an upper stage 131 side, a restoring function of the elastic member 104 or the like is more smoothly performed.

Moreover, in the above description, the holding of the substrates 111, 112 is released in a state in which the upper stage 131 presses the upper substrate 111. However, to more securely perform the releasing operation, in addition to the simple releasing of the adsorption or the like, for example, the upper stage 131 may also be momentarily slightly raised or operated by the pressing mechanism 106 so that the upper stage 131 with respect to the upper substrate 111 is reduced or zeroed.

The control device 107 in the second and third embodiments performs the positioning operation based on the photographed pattern of the alignment mark at the bonding operation time (Steps 8B and 9B). Thereafter, the deformation of the elastic member 104 by the positioning operation is canceled, and the control is executed so as to prevent the restoring force of the deformed elastic member 104 from deteriorating the bonding precision of the both substrates.

That is, the control device 107 drives/controls the X-Y-θ movement mechanism 105 in order to align the lower substrate 112 with the upper substrate 111 based on positional shift data between the substrates 111, 112 by the photographed pattern. However, since the X-Y-θ movement mechanism 105 moves/adjusts the lower substrate 112 via the elastic member 104 which is an elastic body, therefore the elastic member 104 is deformed as described above, and time is required for the positioning operation.

To solve the problem, an association of the positional shift amount between the substrates 111, 112 with the deformation amount of the elastic member 104 is obtained beforehand by an experiment or the like. Accordingly, the control device 107 controls the X-Y-θ movement mechanism 105 in consideration of the deformation of the elastic member 104, and is capable of smoothly and quickly performing the positioning operation.

That is, in a fourth embodiment of the substrate bonding apparatus and bonding method according to the present invention, unlike the second and third embodiments, the control device 107 reads the deformation amount of the elastic member 104 during the correction of the positional shift amount from the data obtained beforehand to add the amount to the first positional shift amount detected based on the photographed pattern of the alignment mark, and drives/controls the X-Y-θ movement mechanism 105.

That is, the control device 107 obtains correspondence data between the positional shift amount between the opposite substrates 111, 112 at the bonding time and the deformation amount of the elastic member 104 deformed as a result of the correction of the positional shift amount beforehand by the experiment or the like, and stores the data in a built-in ROM or the like.

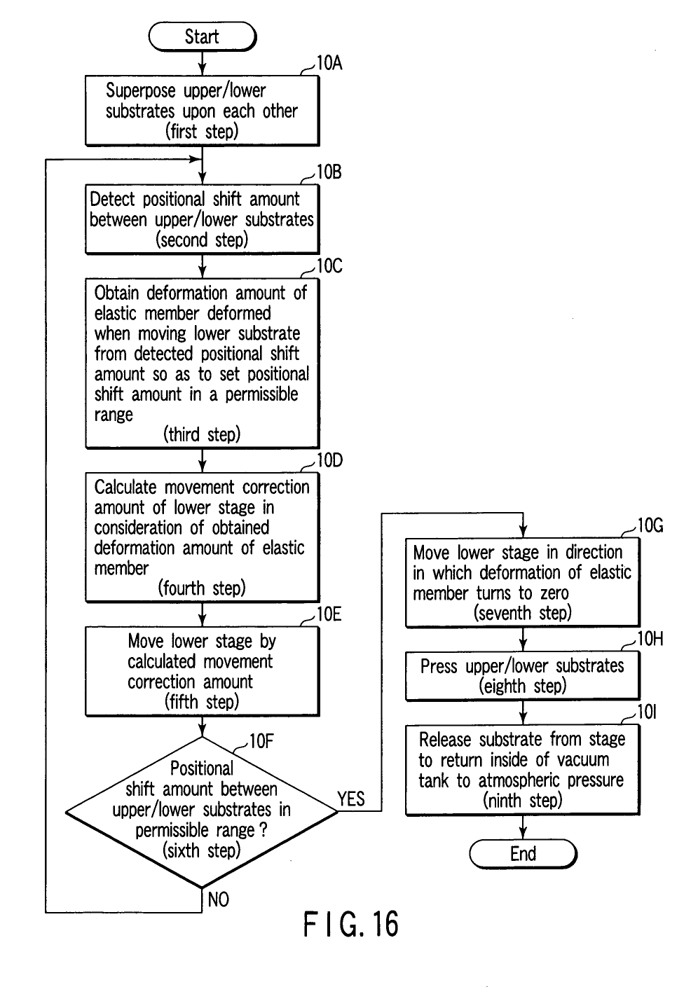

Next, the procedure (Steps) of the method of bonding the substrates according to the fourth embodiment will be described with reference to a flowchart shown in FIG. 16. It is assumed that both the upper/lower substrates 111, 112 are supplied into the vacuum tank 102 and adsorbed/held by both the upper/lower stages 131, 132, and the pressure in the vacuum tank 102 is already reduced in the vacuum state.

In a first step, the upper/lower substrates 111, 112 are superposed upon each other via the adhesive 101a (Step 10A).

In a second step, the positional shift amount between the upper/lower substrates 111, 112 is detected (Step 10B).

In a third step, the information that corresponds to the positional shift amount detected in the second step is read from the ROM. This information will be used to correct the shift amount to one that falls within a preset tolerance range (Step 10C).

In a fourth step, the control device 107 calculates the correction movement amount (e.g., correction amount obtained by adding the deformation amount of the elastic member 104 obtained in the third step to the positional shift amount detected in the second step) with respect to the lower stage 132, from the deformation amount of the elastic member 104 obtained in the third step and the positional shift amount detected in the second step (Step 10D).

In a fifth step, the control device 107 controls the X-Y-θ movement mechanism 105, and drives the lower stage 132 by the correction movement amount calculated in the fourth step (Step 10E).

Next, in a sixth step, the control device 107 judges whether or not the positional shift amount between the upper/lower substrates 111, 112 is within the preset permissible range based on the picked-up image patterns of the alignment marks 111a, 112a by the image pickup apparatuses 133, 133 (Step 10E).

In a seventh step, when it is judged in the sixth step that the positional shift amount between the upper/lower substrates 111, 112 is within the preset permissible range (YES), the control device 107 obtains the deformation amount of the elastic member 104 using the third step of the second embodiment to move the lower stage 132 in a direction in which the deformation amount of the elastic member 104 turns to zero (Step 10G). Subsequently, in an eighth step, the control device 107 controls the pressing mechanism 106, which further presses the adhesive 101a to press the opposite substrates 111, 112 for the preset time (Step 10H).

It is to be noted that the deformation amount of the elastic member 104 obtained in the third step (Step 10C) may also be used as the deformation amount of the elastic member 104. However, a difference is sometimes generated between the deformation amount of the elastic member 104 based on the stored data and the actual deformation amount. Therefore, when the actual deformation amount is obtained, as in the third step of the second embodiment, the deformation of the elastic member 104 can be securely eliminated.

Finally in the ninth step, both the upper/lower substrates 111, 112 are released from both the upper/lower stages 131, 132, and the inside of the vacuum tank 102 is returned to atmospheric pressure (Step 10I).

After the inside of the vacuum tank 102 is returned to atmospheric pressure, the upper stage 131 is raised, and the bonded substrates 111, 112 are taken out of the vacuum tank 102 by the conveying robot (not shown), and are conveyed into the next step, such as the step of hardening the adhesive 101a.

When it is judged in the sixth step that the positional shift amount between the upper/lower substrates 111, 112 is not within the preset permissible range (NO), the procedure returns to the second step (Step 10B), and the control device 107 again operates to detect the positional shift amount between the upper/lower substrates 111, 112, and thereafter repeats the above-described procedure.

Since the lower stage 132 is moved in consideration of the deformation amount of the elastic member 104 in the positioning operation between both the upper/lower substrates 111, 112 in this manner in the fourth embodiment, the positioning operation can be speeded up.

It is to be noted that in the above description, the method described in the second and third embodiments is usable in the cancellation operation of the deformation in the elastic member 104, after the elastic member 104 is deformed and the positioning is performed.

Therefore, according to the fourth embodiment, the deterioration of each positional precision between both the upper/lower substrates 111, 112 after positioned can be avoided or inhibited through the smooth and efficient positioning operation.

It is to be noted that in the above-described embodiments, five elastic members 104 in total, including one member in the middle portion and the member in each of the four corner portions, are disposed with respect to the rectangular substrates 111, 112, but the number of members may be appropriately increased/decreased in accordance with the substrate size. For arrangement positions, all the elastic members 104 may also be used for the substrate having any size, or the elastic member 104 for use may also be appropriately selected in accordance with the substrate size.

Moreover, it has been described above that the elastic members 104 are disposed in the middle portion and four corners of the substrate 111 or 112. However, with a so-called multiple substrate in which a plurality of display regions are formed, the members may also be disposed in the middle portion and four corners of each of display surfaces.

Furthermore, it has been described in the embodiments that the upper substrate 111 is moved downwards for the positioning between the upper/lower substrates 111, 112, but the lower substrate 112 may also be moved upwards. Additionally, the X-Y-θ movement mechanism may also be disposed on an upper stage 131 side, not on the lower stage 132 side, or may also be disposed on the opposite sides so as to share the moving operation in the X-Y-θ direction. In this case, needless to say, the image pickup apparatus 133 may also be appropriately constituted/disposed in accordance with the mechanisms.

Moreover, the elastic member 104 in which the strain gauge 108 is built may also be attached to the upper stage, not to the lower stage, or to both the upper/lower stages.

Furthermore, the pressing operation with respect to the adhesive 101a after the positioning between the upper/lower substrates 111, 112 may also be performed using an inner/outer pressure difference in the bonded substrates 111, 112 by a pressure rise in the vacuum tank 102 instead of using the pressing mechanism 106.

Additionally, an example for performing the positioning in a state in which the upper substrate 111 contacts the adhesive 101a applied onto the lower substrate 112 has been described. However, since the upper substrate 111 or the lower substrate 112 is applied with intervening materials other than the adhesive 101a, such as the liquid crystal member 101b, both the upper/lower substrates 111, 112 are supposedly positioned into contact with only the liquid crystal member 101b, or both the adhesive 101a and the liquid crystal member 101b.

Even in this case, the elastic member 104 between the lower substrate 112 and the lower stage 132 receives resistance from the upper substrate 111 or lower substrate 112 in the direction the substrate 111 or 112 is moving. This is because the viscosity of the liquid crystal member 101b or both the liquid crystal member 101b and the adhesive 101a is viscous. Therefore, the above-described embodiments is applicable.

Moreover, the example has been described in which both the upper/lower substrates 111, 112 are pressurized by the upper stage 131 for the preset time, thereafter the adsorbing/holding of both the upper/lower substrates 111, 112 by both the upper/lower stages 131, 132 is released, and subsequently the inside of the vacuum tank 102 is returned to atmospheric pressure. However, the present invention is not limited to this. After returning the inside of the vacuum tank 102 to atmospheric pressure, or in the process of the returning to atmospheric pressure, the adsorbing/holding of both the upper/lower substrates 111, 112 by both the upper/lower stages 131, 132 may also be released.

Moreover, the adsorbing/holding of both the upper/lower substrates 111, 112 by both the upper/lower stages 131, 132 may also be released simultaneously or at different timings.

Furthermore, when the coefficient of elasticity of the elastic member 104 is not isotropic, the elastic members may also be arranged so that a vertical elasticity coefficient is smaller than a transverse elasticity coefficient. In this case, the elastic member 104 may be constituted to be soft in the bonding direction of both the upper/lower substrates 111, 112 and to be rigid in the positioning direction of both the upper/lower substrates 111, 112 at the positioning operation time. Therefore, the concave/convex portion between the upper/lower stages 131, 132 is satisfactorily absorbed, and the deformation at the positioning operation time can be reduced as much as possible.

Additionally, the lower stage 132 in the vacuum tank 102 may also include a function of receiving/transferring the upper/lower substrates 111, 112. That is, although not shown, a large number of vertically movable lift pins driven by driving sources such as an air cylinder may be arranged avoiding the elastic members 104, so as to be projectable/retrojectable with respect to the lower stage 132. The upper substrate 111 or the lower substrate 112 is received from the conveying robot (not shown) in a step in which the lift pins are moved upwards. Moreover, the upper substrate 111 is transferred to the upper stage 131 from the lift pins. The lower substrate 112 is transferred to the lower stage 132 via the lift pins moved downwards.

According to the apparatus for bonding the substrates and the method of bonding the substrates according to the present invention described above, the elastic member for uniform and high-quality elastic member bonding is deformed in the positioning operation, but the bonding precision can be prevented from being deteriorated by the restoring force. With the use of the apparatus and method in steps of manufacturing liquid crystal substrates or the like, superior effects can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A method of bonding substrates, characterized by comprising:
bringing two substrates into contact with each other via a sealing agent or a liquid substance;
obtaining a positional shift amount between two substrates brought into contact; and
moving at least one of the two substrates by a correction movement amount obtained by multiplying the positional shift amount by a correction coefficient which is larger than 1 to correct a positional shift between these two substrates.

2. A method of bonding substrates, in which one of two substrates is applied with a sealing agent to seal a liquid substance, and the two substrates are bonded to each other by this sealing agent, characterized by comprising:
holding one substrate and the other substrate apart from each other in a vertical direction;
picking up images of the two held substrates to obtain a positional shift amount between the two substrates based on an image pickup result;
positioning two substrates based on the positional shift amount and subsequently bringing these substrates into contact with each other via the sealing agent or the liquid substance;
picking up images of the two substrates brought into contact to obtain a positional shift amount between the two substrates; and
moving at least one of the two substrates by a correction movement amount obtained by multiplying the positional shift amount between the two substrates brought into contact by a correction coefficient which is larger than 1 to correct a positional shift between these substrates.

3. The method of bonding the substrates according to claim 1 or 2, characterized in that assuming that the correction coefficient is K, the previous correction movement amount of the substrate is M, the previous shift amount between the two substrates is δn, and the present shift amount after moving at least one substrate by the correction movement amount M is δm in a case where correction of the positional shift between the two substrates brought into contact is performed a plurality of times, the correction coefficient K is K=f(S), and S=M/(δn−δm) is obtained.

4. The method of bonding the substrates according to claim 1 or 2, characterized in that either a set value larger than 1 which is preset or a calculated value obtained by calculation is selectively used as the correction coefficient based on the positional shift amount between the two substrates in a case where correction of the positional shift between the two substrates is performed a plurality of times.

5. The method of bonding the substrates according to claim 1 or 2, characterized in that the correction coefficient is a set value larger than 1.

6. The method of bonding the substrates according to claim 1, characterized by further comprising: a measurement step of confirming whether or not there is a shift between the two substrates, after moving at least one of the two substrates to correct the positional shift between these substrates.

7. The method of bonding the substrates according to claim 1 or 2, characterized in that the correction movement amount in moving at least one of the two substrates to correct the positional shift between these substrates is a movement amount which offsets the shift amount in a case where a shift is caused between the two substrates after the correction movement.

8. A method of bonding substrates, characterized by comprising:
bringing two substrates into contact with each other via a sealing agent or a liquid substance;
obtaining a positional shift amount between two substrates brought into contact; and
moving at least one of the two substrates by a correction movement amount obtained by multiplying the positional shift amount by a correction coefficient to correct the positional shift amount between these two substrates.

9. An apparatus for bonding substrates, in which at least one of two substrates is applied with a sealing agent to seal a liquid material, and the two substrates are bonded to each other by this sealing agent, characterized by comprising:
a holding device which holds one substrate and the other substrate apart from each other in a vertical direction and which relatively drives these substrates in X, Y, Z, and θ directions to bond the two substrates to each other;
an image pickup device which picks up images of the two substrates held by the holding device; and
a control device which obtains a positional shift amount between the two substrates based on an image pickup result of the image pickup device and which moves at least one of the two substrates by a correction movement amount obtained by multiplying the positional shift amount by a correction coefficient which is larger than 1 to correct a positional shift between these substrates.

10. The apparatus for bonding the substrates according to claim 9, characterized by further comprising:
a storage device which sets a threshold value concerning the positional shift amount between the two substrates, a set value larger than 1, which is the correction coefficient, and an equation by which the correction coefficient is calculated,
wherein the control device selects use of the set value larger than 1, set in the storage device or use of a calculated value obtained by the equation as the correction coefficient based on the positional shift amount between the two substrates.

11. The apparatus for bonding the substrates according to claim 9, characterized in that the image pickup device comprises:
a first image pickup device which picks up images of the two substrates held apart from each other in the vertical direction;
a second image pickup device which picks up images of the two substrates brought closer to each other as compared with an image pickup time by the first image pickup device and whose image pickup magnification is higher than that of the first image pickup device; and
a positioning device which positions at least one of the first and second image pickup devices in accordance with an image pickup position at a time when the images of the substrates are picked up by the first and second image pickup devices.

12. The apparatus for bonding the substrates according to claim 9, characterized in that the control device comprises: a storage device in which the positional shift amount between the two substrates obtained from an image pickup result of the image pickup device upon every correction is stored in order to calculate the correction coefficient in a case where correction of the positional shift of the substrates is performed a plurality of times.

13. The apparatus for bonding the substrates according to claim 12, characterized in that assuming that the correction coefficient is K, the previous correction movement amount of the substrate is M, the previous shift amount between the two substrates is δn, and the present shift amount after moving at least one substrate by the correction movement amount M is δm, the control device calculates the correction coefficient K based on equations of K=f(S), and S=M/(δn−δm).

14. An apparatus for bonding substrates, in which an upper substrate held on an upper stage is bonded to a lower substrate disposed to face the upper substrate and held on a lower stage via an adhesive, the apparatus characterized by comprising:
an elastic member interposed between the upper stage and the upper substrate or between the lower stage and the lower substrate;
a detection device which detects a deformation amount of the elastic member in a horizontal direction; and
a driving control device which moves the upper stage relative to the lower stage, based on the deformation amount detected by the detection device.

15. The apparatus for bonding the substrates according to claim 14, characterized in that a vertical elastic coefficient of the elastic member is smaller than a transverse elastic coefficient, and the elastic member is elastically deformed in accordance with the vertical elastic coefficient, when moved in a direction in which the upper substrate is bonded to the lower substrate.

16. An apparatus for bonding substrates, in which an upper substrate held on an upper stage is bonded to a lower substrate disposed to face the upper substrate and held on a lower stage via an adhesive, the apparatus characterized by comprising:
an elastic member interposed between the upper stage and the upper substrate or between the lower stage and the lower substrate;
a detection device which detects a positional shift amount of a horizontal direction between the upper stage and the upper substrate or between the lower substrate and the lower stage via the elastic member; and
a driving control device which moves the upper stage relative to the lower stage, based on the positional shift amount detected by the detection device.

17. The apparatus for bonding the substrates according to claim 16, characterized in that the detection device comprises a strain gauge which measures a deformation amount of the elastic member.

18. The apparatus for bonding the substrates according to claim 16, characterized in that the driving control device is constituted to restrict a relative movement amount between the upper and lower stages based on the positional shift amount.

19. A method of bonding substrates, in which an elastic member is disposed between an upper stage and an upper substrate held on the upper stage or between a lower stage and a lower substrate held on the lower stage, and a positioning operation of the upper and lower substrates is performed in a contact state via intervening materials such as an adhesive to bond the substrates to each other via the adhesive, the method characterized by comprising:
superposing the upper substrate upon the lower substrate via the intervening materials;
controlling a relative position between the upper stage and the lower stage after superposing the upper substrate upon the lower substrate via the intervening materials to perform the positioning operation between the upper and lower substrates;
detecting a deformation amount of the elastic member in a horizontal direction after positioning the upper substrate with the lower substrate; and
moving the upper stage relative to the lower stage in a direction in which the deformation amount of the elastic member is reduced after detecting the deformation amount of the elastic member in the horizontal direction.

20. A method of bonding substrates, in which an elastic member is disposed between an upper stage and an upper substrate held on the upper stage or between a lower stage and a lower substrate held on the lower stage, and a positioning operation of the upper and lower substrates is performed in a contact state via intervening materials such as an adhesive to bond the substrates to each other via the adhesive, the method characterized by comprising:
superposing the upper substrate upon the lower substrate via the intervening materials;
controlling a relative position between the upper stage and the lower stage after superposing the upper substrate upon the lower substrate via the intervening materials to perform the positioning operation between the upper and lower substrates;
obtaining a horizontal shift amount of the upper or lower substrate after positioning the upper and lower substrates with respect to each other, based on deformation of the elastic member held between the upper or lower substrate and the stage holding the substrate; and
moving the upper stage relative to the lower stage in a direction in which the horizontal positional shift amount is reduced after obtaining the horizontal positional shift amount between the substrate and the stage based on the deformation of the elastic member.

21. The method of bonding the substrates according to claim 20, characterized in that for the positioning of the upper substrate with the lower substrate, a relation of the positional shift amount between the upper and lower substrates relative to a deformation amount of the elastic member generated at a time of correction of the positional shift amount is obtained beforehand, and the upper and lower substrates are positioned based on a correction movement amount obtained by adding the deformation amount of the elastic member in accordance with the positional shift amount to the positional shift amount between the upper and lower substrates.

22. The method of bonding the substrates according to claim 20, characterized in that the horizontal positional shift amount between the substrate and the stage is calculated based on the deformation amount of the elastic member measured by a strain gauge.

23. The method of bonding the substrates according to claim 20, characterized in that the moving of the upper stage relative to the lower stage in the direction in which the horizontal positional shift amount is reduced comprises: imposing a restriction on a amount of relative motion of the upper and lower stages.

24. A method of bonding substrates, in which an elastic member is disposed between an upper stage and an upper substrate held on the upper stage or between a lower stage and a lower substrate held on the lower stage, and a positioning operation of the upper and lower substrates is performed in a contact state via intervening materials such as an adhesive to bond the substrates to each other via the adhesive, the method characterized by comprising:
superposing the upper substrate upon the lower substrate via the intervening materials;
controlling a relative position between the upper stage and the lower stage after superposing the upper substrate upon the lower substrate via the intervening materials to perform the positioning operation between the upper and lower substrates;
releasing either the holding of the upper substrate by the upper stage or the holding of the lower substrate by the lower stage after positioning the upper substrate with the lower substrate; and
bonding the upper substrate to the lower substrate after releasing the holding of the upper or lower substrate.
